(19) United States
(12) Patent Application Publication
(10) Pub. No.: US 2026/0134837 A1
(43) Pub. Date: May 14, 2026

(54) VOLTAGE SETTING METHOD OF DISPLAY DEVICES, AND ELECTRONIC DEVICE

(71) Applicant: Samsung Display Co., Ltd., Yongin-si (KR)

(72) Inventors: Cheol Hwan EOM, Yongin-si (KR); Do Yeong KANG, Yongin-si (KR); Hyeon Woong KANG, Yongin-si (KR); Mi Kyung KANG, Yongin-si (KR); Min Woong AHN, Yongin-si (KR); Sang Hun LEE, Yongin-si (KR)

(21) Appl. No.: 19/253,121

(22) Filed: Jun. 27, 2025

(30) Foreign Application Priority Data
Nov. 13, 2024 (KR) 10-2024-0161259
Dec. 24, 2024 (KR) 10-2024-0195802

(51) Int. Cl. G09G 3/3258

(52) U.S. Cl. CPC G09G 3/3258; G09G 2300/0819; G09G 2300/0866; G09G 2310/08; G09G 2320/0233; G09G 2320/0626

(57) ABSTRACT

A voltage setting method of display devices including pixels to generate light based on a reference voltage and a voltage of a data signal, includes: determining a first reference voltage corresponding to the reference voltage at a first dimming level, based on a first black voltage corresponding to a black data signal at the first dimming level; determining a second reference voltage corresponding to the reference voltage at a second dimming level by adding a first offset voltage to the first reference voltage; and determining a second black voltage corresponding to a black data signal at the second dimming level, based on the second reference voltage.

### CROSS-REFERENCE TO RELATED APPLICATION

The present application claims priority to and the benefit of Korean Patent Application Number 10-2024-0161259, filed on Nov. 13, 2024, and Korean Patent Application Number 10-2024-0195802, filed on Dec. 24, 2024, in the Korean Intellectual Property Office, the entire disclosures of all of which are incorporated by reference herein.

### BACKGROUND

### 1. Field

Aspects of embodiments of the present disclosure relate to a voltage setting method of display devices, and an electronic device.

### 2. Description of the Related Art

With the development of information technology, the importance of display devices as a medium for connection between a user and information has become increasingly important. As such, the uses of display devices, such as Liquid Crystal Display Devices, Organic Light Emitting Display Devices, and the like, are increasing.

### SUMMARY

Embodiments of the present disclosure may be directed to a voltage setting method of display devices, a display device, and an electronic device for improving a display quality.

According to one or more embodiments of the present disclosure, a voltage setting method of display devices including pixels configured to generate light based on a reference voltage and a voltage of a data signal, includes: determining a first reference voltage corresponding to the reference voltage at a first dimming level, based on a first black voltage corresponding to a black data signal at the first dimming level; determining a second reference voltage corresponding to the reference voltage at a second dimming level by adding a first offset voltage to the first reference voltage; and determining a second black voltage corresponding to a black data signal at the second dimming level, based on the second reference voltage.

In an embodiment, the first black voltage in at least two of the display devices may have a same voltage value, and the second black voltage in the at least two of the display devices may have different voltage values from each other.

In an embodiment, the first dimming level may have a smallest AMOLED Off Ratio (AOR), and the second dimming level may have a largest AOR.

In an embodiment, the first reference voltage may have a greater voltage value than that of the first black voltage, and the second reference voltage may have a greater voltage value than that of the second black voltage.

In an embodiment, the method may further include determining reference voltages for dimming levels located between the first dimming level and the second dimming level by interpolating the first reference voltage and the second reference voltage.

In an embodiment, the method may further include determining black voltages for dimming levels located between the first dimming level and the second dimming level by interpolating the first black voltage and the second black voltage.

In an embodiment, the determining of the first reference voltage may include: determining a temporary first reference voltage at which a black driving condition for the first dimming level is secured, based on the first black voltage; and determining the first reference voltage by adding a second offset voltage to the temporary first reference voltage.

In an embodiment, the determining of the second black voltage may include: determining a temporary black voltage at which a black driving condition is secured at the second dimming level, based on the second reference voltage; and determining the second black voltage by subtracting a third offset voltage from the temporary black voltage.

In an embodiment, the third offset voltage may have a greater voltage value than that of the second offset voltage.

In an embodiment, the determining of the second black voltage may include: determining a voltage obtained by subtracting the second offset voltage from the second reference voltage as a temporary second reference voltage; and determining the second black voltage satisfying a black driving condition at the second dimming level, based on the temporary second reference voltage.

According to one or more embodiments of the present disclosure, a voltage setting method of display devices including pixels configured to be driven based on a reference voltage and a voltage of a data signal, includes: determining a temporary first reference voltage satisfying a black driving condition, based on a first black voltage corresponding to a black data signal at a first dimming level; determining a first reference voltage corresponding to the reference voltage at the first dimming level by adding a first offset voltage to the temporary first reference voltage; determining a second reference voltage corresponding to the reference voltage at a second dimming level by adding a second offset voltage to the first reference voltage; determining a temporary second reference voltage by subtracting the first offset voltage from the second reference voltage; and determining a second black voltage corresponding to the black data signal at the second dimming level, based on the temporary second reference voltage.

In an embodiment, the first black voltage in at least two of the display devices may have a same voltage value, and the second black voltage in the at least two of the display devices may have different voltage values from each other.

In an embodiment, the first dimming level may have a smallest AMOLED Off Ratio (AOR), and the second dimming level may have a largest AOR.

In an embodiment, the first reference voltage may have a greater voltage value than that of the first black voltage, and the second reference voltage may have a greater voltage value than that of the second black voltage.

In an embodiment, the method may further include determining reference voltages for dimming levels located between the first dimming level and the second dimming level by interpolating the first reference voltage and the second reference voltage.

In an embodiment, the method may further include determining black voltages for dimming levels located between the first dimming level and the second dimming level by interpolating the first black voltage and the second black voltage.

According to one or more embodiments of the present disclosure, an electronic device includes: a first display panel; a second display panel; and a processor configured to drive the first display panel and the second display panel. Voltages of black data signals at a first dimming level are the same in the first display panel and the second display panel, and voltages of black data signals at a second dimming level are different in the first display panel and the second display panel.

In an embodiment, the first dimming level may have a smallest AMOLED Off Ratio (AOR), and the second dimming level may have a largest AOR.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a diagram illustrating a display device according to some embodiments of the present disclosure.

FIG. 2 is a diagram illustrating a scan driver and an emission driver shown in FIG. 1 according to some embodiments of the present disclosure.

FIG. 3 is a diagram illustrating a pixel according to some embodiments of the present disclosure.

FIG. 4 is a waveform diagram illustrating a method of driving the pixel of FIG. 3 according to some embodiments of the present disclosure.

FIG. 5 is a diagram illustrating an AMOLED Off Ratio (AOR) based on a dimming level according to an embodiment of the present disclosure.

FIG. 6 is a flowchart illustrating a voltage setting method of display devices according to some embodiments of the present disclosure.

FIG. 7 is a diagram illustrating the voltage setting method of FIG. 6.

FIG. 8 is a flowchart illustrating a voltage setting method of display devices according to some embodiments of the present disclosure.

FIG. 9 is a diagram illustrating the voltage setting method of FIG. 8.

FIG. 10 is a block diagram of an electronic device according to some embodiments of the present disclosure.

FIG. 11 shows schematic views of various electronic devices according to some embodiments of the present disclosure.

FIG. 12 is a diagram illustrating an application example of the electronic device of FIG. 10.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for convenience of illustration to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Some embodiments of the present disclosure may be described in relation to a functional block, a unit, and/or a module. Those having ordinary skill in the art should understand that such a block, unit, and/or module are/is physically implemented by a logic circuit, an individual component, a microprocessor, a hard wire circuit, a memory element, a line connection, and/or other electronic circuits. These elements may be formed using a semiconductor-based manufacturing technique or other suitable manufacturing techniques. The block, unit, and/or module implemented by a microprocessor or other similar hardware device may be programmed and controlled using software to perform various functions disclosed herein, and optionally, may be driven by firmware and/or software. In addition, each block, unit, and/or module may be implemented by a dedicated hardware, or a combination of a dedicated hardware that performs some functions and a processor (e.g., one or more programmed microprocessors and related circuits) that performs a function different from those of the dedicated hardware. In addition, in some embodiments, the block, unit, and/or module may be physically separated into two or more interactive individual blocks, units, and/or modules. In addition, in some embodiments, the block, unit and/or module may be physically combined into more complex blocks, units, and/or modules.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

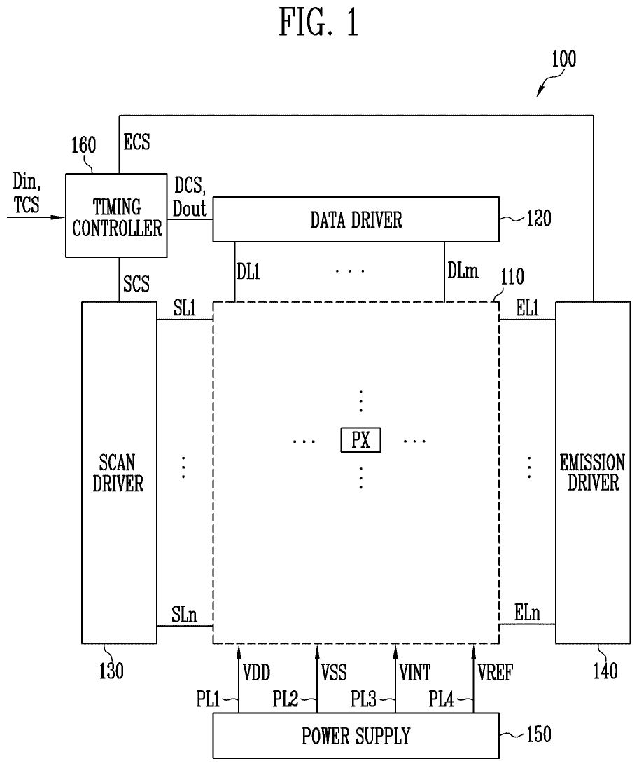

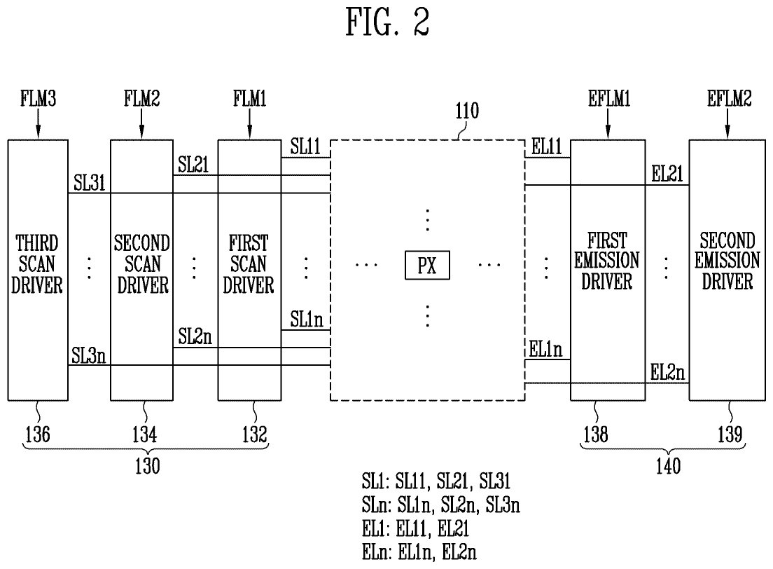

FIG. 1 is a diagram illustrating a display device 100 according to some embodiments of the present disclosure. FIG. 2 is a diagram illustrating a scan driver and an emission driver shown in FIG. 1 according to some embodiments of the present disclosure.

Referring to FIG. 1, the display device 100 according to some embodiments of the present disclosure may include a display panel 110, a data driver 120, a scan driver 130, an emission driver 140, a power supply 150, and a timing controller 160.

The display panel 110 may include pixels PX connected to scan lines SL1 to SLn, data lines DL1 to DLm, emission control lines EL1 to ELn, and power lines PL1, PL2, PL3, and PL4, where n and m are natural numbers of two or more.

In an embodiment, each of the scan lines SL1 to SLn may include three scan lines, as shown in FIG. 2. For example, the scan line SL1 may include a first scan line SL11, a second scan line SL21, and a third scan line SL31. For example, the scan line SLn may include a first scan line SL1n, a second scan line SL2n, and a third scan line SL3n.

The pixels PX are selected in units of horizontal lines when an enable first scan signal is supplied to the first scan lines SL11 to SL1n. Each of the pixels PX selected by the enable first scan signal may receive a data signal from one corresponding data line (e.g., among the data lines DL1 to DLm) connected thereto. The pixels PX receiving the data signal may generate light of a desired luminance (e.g., a predetermined luminance) in response to a voltage of the data signal.

The scan driver 130 may receive a scan driving signal SCS from the timing controller 160. The scan driving signal SCS may include at least one scan start signal and clock signals used to drive the scan driver 130. The scan driver 130 may generate an enable first scan signal, an enable second scan signal, and an enable third scan signal by shifting the scan start signal in response to the clock signal.

In an embodiment, the scan driver 130 may include a first scan driver 132, a second scan driver 134, and a third scan driver 136, as shown in FIG. 2. Depending on the design, at least some of the scan drivers 132, 134, and 136 may be integrated into a single driver circuit, module, or the like.

The first scan driver 132 may receive a first scan start signal FLM1, and may generate an enable first scan signal by shifting the first scan start signal FLM1 in response to a clock signal. The first scan driver 132 may sequentially supply the enable first scan signal to the first scan lines SL11 to SL1n.

The second scan driver 134 may receive a second scan start signal FLM2, and may generate an enable second scan signal by shifting the second scan start signal FLM2 in response to the clock signal. The second scan driver 134 may sequentially supply the enable second scan signal to the second scan lines SL21 to SL2n.

The third scan driver 136 may receive a third scan start signal FLM3, and may generate an enable third scan signal by shifting the third scan start signal FLM3 in response to a clock signal. The third scan driver 136 may sequentially supply the enable third scan signal to the third scan lines SL31 to SL3n.

The enable first scan signal, the enable second scan signal, and the enable third scan signal may each have a gate-on voltage so that transistors included in the pixels PX may be turned on. For example, the enable first scan signal, the enable second scan signal, and the enable third scan signal supplied to an N-type transistor may have (e.g., may be set to) a logic high-level voltage.

The data driver 120 may receive output data Dout and a data driving signals DCS from the timing controller 160. The data driving signal DCS may include a sampling signal and/or timing signals used to drive the data driver 120. The data driver 120 may generate a data signal based on the data driving signal DCS and the output data Dout. For example, the data driver 120 may generate an analog data signal based on a grayscale (e.g., a grayscale value or level) of the output data Dout. The data driver 120 may supply a data signal to the data lines DL1 to DLm in units of one horizontal period.

In an embodiment, each of the emission control lines EL1 to ELn may include two emission control lines, as shown in FIG. 2. For example, the emission control line EL1 may include a first emission control line EL11 and a second emission control line EL21. For example, the emission control line ELn may include a first emission control line EL1n and a second emission control line EL2n.

The emission driver 140 may receive an emission driving signal ECS from the timing controller 160. The emission driving signal ECS may include an emission start signal and clock signals used to drive the emission driver 140. The emission driver 140 may generate a disable first emission control signal and a disable second emission control signal by shifting an emission start signal in response to a clock signal.

In an embodiment, the emission driver 140 may include a first emission driver 138 and a second emission driver 139, as shown in FIG. 2. Depending on the design, the first and second emission drivers 138 and 139 may be integrated into a single driver circuit, module, or the like.

The first emission driver 138 may generate a disable first emission control signal by shifting a first emission start signal EFLM1 in response to a clock signal. The first emission driver 138 may sequentially supply the disable first emission control signal to the first emission control lines EL11 to EL1n. The first emission driver 138 may supply an enable first emission control signal to the first emission control lines EL11 to EL1n during a period in which the disable first emission control signal is not supplied.

The second emission driver 139 may generate a disable second emission control signal by shifting a second emission start signal EFLM2 in response to a clock signal. The second emission driver 139 may sequentially supply the disable second emission control signal to the second emission control lines EL21 to EL2n. The second emission driver 139 may supply an enable second emission control signal to the second emission control lines EL21 to EL2n during a period in which the disable second emission control signal is not supplied.

The disable first emission control signal and the disable second emission control signal may have (e.g., may be set to) a gate-off voltage so that the transistors included in the pixels PX may be turned off. For example, the disable first emission control signal and the disable second emission control signal supplied to an N-type transistor each may have (e.g., may be set to) a logic low-level voltage.

The enable first emission control signal and the enable second emission control signal each may have (e.g., may be set to) a gate-on voltage so that the transistors included in the pixels PX may be turned on. For example, the enable first emission control signal and the enable second emission control signal supplied to the N-type transistor each may have (e.g., may be set to) a logic high-level voltage.

The timing controller 160 may receive input data Din and timing control signals TCS from a host system via an interface. For example, the timing controller 160 may receive the input data Din and a timing control signal TCS from at least one of a graphics processing unit (GPU), a central processing unit (CPU), or an application processor (AP) included in the host system. The timing control signal TCS may include various suitable signals, including a clock signal.

The timing controller 160 may generate the scan driving signal SCS, the data driving signal DCS, and the emission driving signal ECS based on the timing control signal TCS. The timing control signal TCS, the data driving signal DCS, and the emission driving signal ECS may be supplied to the scan driver 130, the data driver 120, and the emission driver 140, respectively.

The timing controller 160 may realign the input data Din to meet specifications of the display device 100. Further, the timing controller 160 may correct the input data Din to generate the output data Dout, and may supply the output data Dout to the data driver 120. In an embodiment, the timing controller 160 may correct the input data Din in response to optical measurement results obtained during some processes.

The power supply 150 may generate various suitable power sources for driving the display device 100. For example, the power supply 150 may generate a first driving power VDD, a second driving power VSS, an initialization voltage VINT, and a reference voltage VREF.

The first driving power VDD may be a power source that supplies a driving current to the pixels PX. The second driving power VSS may be a power source that receives the driving current from the pixels PX. The first driving power VDD may have (e.g., may be set to) a higher voltage than that of the second driving power VSS during a period in which the pixels PX are in (e.g., are set to) a light emitting state.

The initialization voltage VINT may be supplied to a first electrode (e.g., an anode electrode) of a light emitting device included in each of the pixels PX. The reference voltage VREF may be a supplied to a gate electrode of a driving transistor included in each of the pixels PX.

The first driving power VDD generated by the power supply 150 may be supplied to a first power line PL1, the second driving power VSS may be supplied to a second power line PL2, the initialization voltage VINT may be supplied to a third power line PL3, and the reference voltage VREF may be supplied to a fourth power line PL4. The first power line PL1, the second power line PL2, the third power line PL3, and the fourth power line PL4 may be connected in common with the pixels PX, but the present disclosure is not limited thereto.

In an embodiment, the first power line PL1 includes a plurality of power lines, and the plurality of power lines may be connected to different pixels PX. In an embodiment, the second power line PL2 includes a plurality of power lines, and the plurality of power lines may be in connection with different pixels PX. In an embodiment, the third power line PL3 includes a plurality of power lines, and the plurality of power lines may be in connection with different pixels PX. In an embodiment, the fourth power line PL4 includes a plurality of power lines, and the plurality of power lines may be connected to different pixels PX.

In some embodiments of the present disclosure, the display device 100 may include a planar display device, a curved display device in which a portion of the display panel 110 is curved, a flexible display device in which a portion may be folded or bent, and a stretchable display device in which a portion may be stretched.

In some embodiments of the present disclosure, the display device 100 displays a video or a still image, and may include or be implemented as a portable electronic device, such as a mobile phone, a smart phone, a tablet personal computer (PC), a smart watch, a watch phone, a mobile communication terminal, an electronic notebook, an e-book, a portable multimedia player (PMP), a navigation, an ultra mobile PC (UMPC), and/or the like. In some embodiments of the present disclosure, the display device 100 may include or be implemented as another electronic device, such as a television, a laptop, a monitor, a billboard, an Internet of Things (IoT) device, and/or the like.

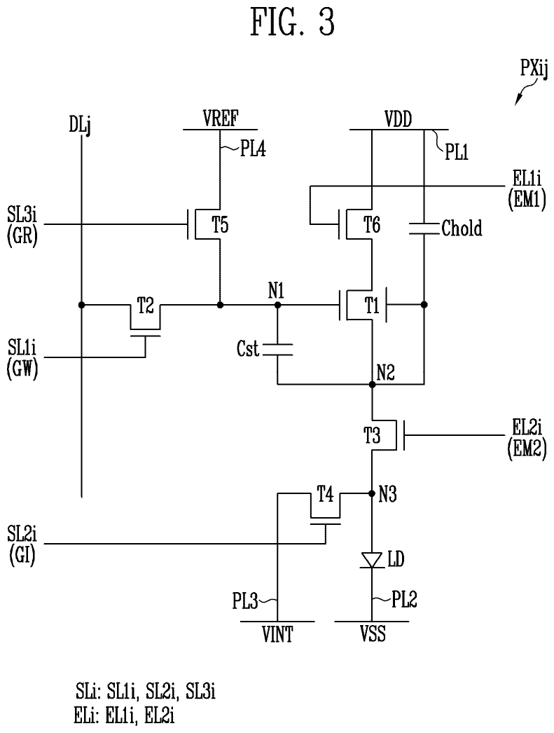

FIG. 3 is a diagram illustrating a pixel according to some embodiments of the present disclosure. FIG. 3 illustrates a pixel PXij located on an i-th horizontal line and a j-th vertical line.

Referring to FIG. 3, the pixel PXij according to some embodiments of the present disclosure may be connected to corresponding signal lines (SLi, DLj, and ELi). For example, the pixel PXij may be connected to an i-th scanning line SLi, an i-th emission control line ELi, and a j-th data line DLj (where i is a natural number from 1 to n or less, and j is a natural number from 1 to m or less). The i-th scanning line SLi may include a plurality of scan lines SL1i, SL2i, and SL3i. The i-th emission control line ELi may include a plurality of emission control lines EL1i and EL2i. The pixel PXij may be further connected to the power lines PL1 to PL4.

The pixel PXij according to some embodiments of the present disclosure may include a light emitting device LD, and a pixel circuit for controlling an amount of current supplied to the light emitting device LD.

The light emitting device LD may be connected between the first power line PL1 and the second power line PL2. For example, a first electrode (e.g., an anode electrode) of the light emitting device LD may be connected to the first power line PL1 via a third node N3, a third transistor T3, a second node N2, a first transistor T1, and a sixth transistor T6. A second electrode (e.g., a cathode electrode) of the light emitting device LD may be connected to the second power line PL2. The light emitting device LD may generate light of a luminance corresponding to the amount of current supplied from the pixel circuit.

The light emitting device LD may be selected as an organic light emitting diode. As another example, the light emitting device LD may be selected as an inorganic light emitting diode, such as a micro light emitting diode (LED), a quantum dot light emitting diode, and the like. In addition, the light emitting device LD may be a device composed of a combination of organic and inorganic materials. In FIG. 3, the pixel PXij is shown as including a single light emitting device LD, but in other embodiments, the pixel PXij may include a plurality of light emitting devices LD. In this case, the plurality of light emitting devices LD may be connected in series, parallel, or series-parallel with each other.

The pixel circuit may include the first transistor T1, a second transistor T2, the third transistor T3, a fourth transistor T4, a fifth transistor T5, the sixth transistor T6, a first capacitor Cst, and a second capacitor Chold. The first to sixth transistors T1 to T6 may be oxide semiconductor transistors. For example, the first to sixth transistors T1 to T6 may include an active layer (e.g., a semiconductor layer) including an oxide semiconductor layer. In an embodiment, the first to sixth transistors T1 to T6 may be N-type oxide semiconductor transistors.

A first electrode of the first transistor T1 (e.g., a driving transistor) may be connected to a second electrode of the sixth transistor T6, and a second electrode of the first transistor T1 may be connected to the second node N2. A first gate electrode of the first transistor T1 may be connected to the first node N1, and a second gate electrode (e.g., a back gate electrode) of the first transistor T1 may be connected to the second node N2. The first transistor T1 may control the amount of the driving current flowing from the first driving power supply VDD to the second driving power supply VSS via the light emitting device LD in response to a voltage of the first node N1.

The first transistor T1 may include a double gate transistor including the first gate electrode and the second gate electrode. When the second gate electrode is connected to the second node N2, a gate-source voltage and a driving current of the first transistor T1 may be stabilized.

The second transistor T2 may be connected between the data line DLj and the first node N1. In addition, a gate electrode of the second transistor T2 may be connected to the first scan line SL1i. The second transistor T2 may be turned on when an enable first scan signal GW (e.g., a high-level first scan signal GW) is supplied to the first scan line SL1i, thereby electrically connecting the data line DLj and the first node N1 to each other.

The third transistor T3 may be connected between the second node N2 and the third node N3. The second node N2 refers to a node to which the second electrode of the first transistor T1 and a first electrode of the third transistor T3 are electrically connected to each other, and the third node N3 refers to a node to which a first electrode of the light emitting device LD is connected. A gate electrode of the third transistor T3 may be connected to a second emission control line EL2i. The third transistor T3 may be turned off when a disable second emission control signal EM2 (e.g., a low-level second emission control signal EM2) is supplied to the second emission control line EL2i, and may be turned on in other cases.

The fourth transistor T4 may be connected between the third node N3 and the third power line PL3. In addition, a gate electrode of the fourth transistor T4 may be connected to the second scanning line SL2i. The fourth transistor T4 may be turned on when an enable second scan signal GI (e.g., a high-level second scan signal GI) is supplied to the second scan line SL2i to electrically connect the third power line PL3 and the third node N3 to each other.

When the third power line PL3 and the third node N3 are electrically connected to each other, the initialization voltage VINT from the third power line PL3 may be supplied to the third node N3. A parasitic capacitor that may be formed equivalent to the light emitting device LD may be discharged, and a black expression ability may be improved accordingly.

The fifth transistor T5 is connected between the fourth power line PL4 and the first node N1. In addition, a gate electrode of the fifth transistor T5 may be connected to the third scan line SL3i. The fifth transistor T5 may be turned on when an enable third scan signal GR (e.g., a high-level third scan signal GI) is supplied to the third scan line SL3i to electrically connect the fourth power line PL4 and the first node N1 to each other. When fourth power supply line PL4 and the first node N1 are electrically connected to each other, the reference voltage VREF may be supplied to the first node N1.

The sixth transistor T6 may be connected between the first power line PL1 and the first electrode of the first transistor T1. In addition, a gate electrode of the sixth transistor T6 may be connected to a first emission control line EL1i. The sixth transistor T6 may be turned off when a disable first emission control signal EM1 (e.g., a low-level first emission control signal EM1) is supplied to the first emission control line EL1i, and may be turned on in other cases.

The first capacitor Cst may be connected between the first node N1 and the second node N2. The first capacitor Cst may store a voltage corresponding to the data signal.

The second capacitor Chold may be connected between the first power line PL1 and the second node N2. The second capacitor Chold may stabilize a voltage of the second node N2.

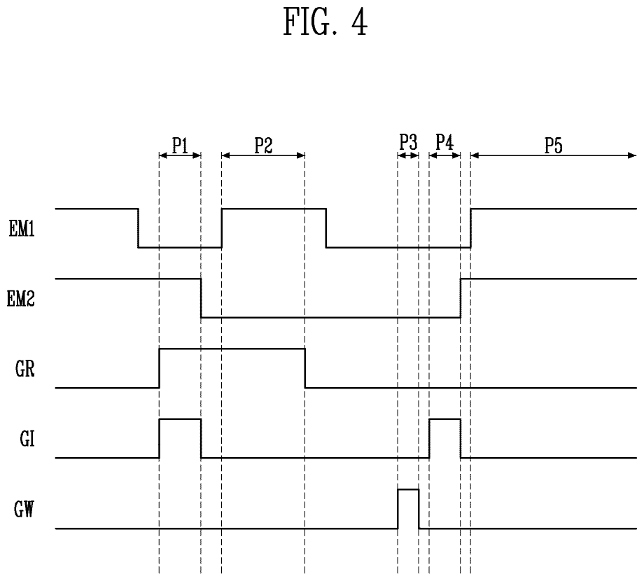

FIG. 4 is a waveform diagram illustrating a method of driving the pixel PXij of FIG. 3 according to some embodiments of the present disclosure.

Referring to FIGS. 3 and 4, the method of driving the pixel PXij may include a first period P1, a second period P2, a third period P3, a fourth period P4, and a fifth period P5.

The first period P1 may be a period for initializing the first capacitor Cst. The second period P2 may be a period for compensating for a threshold voltage of the first transistor T1. The third period P3 may be a period during which the voltage corresponding to the data signal is stored in the pixel PXij. The fourth period P4 may be a period for initializing the light emitting device LD. The fifth period P5 may be a period during which the pixel PXij (or more specifically, the light emitting device LD) emits light.

During the first period P1, the enable second scan signal GI may be supplied to the second scan line SL2i, and the enable third scan signal GR may be supplied to the third scan line SL3i. In addition, during the first period P1, the disable first emission control signal EM1 may be supplied to the first emission control line EL1i, and an enable second emission control signal EM2 (e.g., a high-level voltage) may be supplied to the second emission control line EL2i.

When the disable first emission control signal EM1 is supplied to the first emission control line EL1i, the sixth transistor T6 may be turned off. When the sixth transistor T6 is turned off, an electrical connection between the first power line PL1 and the first transistor T1 may be cut off, and the light emitting device LD may be in (e.g., may be set to) a non-emitting state accordingly.

When the enable second scan signal GI is supplied to the second scan line SL2i, the fourth transistor T4 is turned on. When the fourth transistor T4 is turned on, the initialization voltage VINT may be supplied to the third node N3. When the enable second emission control signal EM2 is supplied to the second emission control line EL2i, the third transistor M3 is turned on. When the third transistor T3 is turned on, the initialization voltage VINT may be supplied to the second node N2.

When the enable third scan signal GR is supplied to the third scan line SL3i, the fifth transistor T5 is turned on. When the fifth transistor T5 is turned on, the reference voltage VREF is supplied to the first node N1. When the reference voltage VREF is supplied to the first node N1 and the initialization voltage VINT is supplied to the second node N2, the first capacitor Cst and the second capacitor Chold may be initialized. In other words, the first period P1 may be a period for initializing the pixel PXij so that the first capacitor Cst and the second capacitor Chold may not be affected by the data signal supplied during a previous frame period.

During the second period P2, an enable first emission control signal EM1 (e.g., a high-level voltage) may be supplied to the first emission control line EL1i, and the enable third scan signal GR may be supplied to the third scan line SL3i. The enable third scan signal GR supplied to the third scan line SL3i may be supplied during the first period P1 and the second period P2.

When the enable first emission control signal EM1 is supplied to the first emission control line EL1i, the sixth transistor T6 is turned on, and accordingly, a voltage of the first driving power VDD may be supplied to the first electrode of the first transistor T1. When the enable third scan signal GR is supplied to the third scan line SL3i, the fifth transistor T5 is turned on, and accordingly, the reference voltage VREF may be supplied to the first node N1.

The reference voltage VREF may have a suitable level (e.g., may be set) so that the first transistor T1 may be turned on, and accordingly, the voltage of the second node N2 may be increased in response to the current supplied from the first transistor T1. For example, the voltage of the second node N2 may be increased to a value obtained by subtracting an absolute threshold voltage of the first transistor T1 from the reference voltage VREF. In other words, during the second period P2, the first capacitor Cst may store a voltage corresponding to the threshold voltage of the first transistor T1.

A width of the second period P2 may be determined by a supply time of the enable first emission control signal EM1 and the enable third scan signal GR. In other words, in an embodiment of the present disclosure, the supply time of the enable first emission control signal EM1 and the enable third scan signal GR may be utilized to control a compensation time (e.g., the second period P2) of the threshold voltage of the first transistor T1.

During the second period P2, the disable second emission control signal EM2 may be supplied to the second emission control line EL2i. When the disable second emission control signal EM2 is supplied to the second emission control line EL2i, the third transistor T3 remains in a turn-off state. Thus, during the second period P2, the second node N2 and the third node N3 may be electrically blocked.

During the third period P3, the disable first emission control signal EM1 is supplied to the first emission control line EL1i, and the sixth transistor T6 is turned off accordingly. During the third period P3, the disable second emission control signal EM2 is supplied to the second emission control line EL2i, and the third transistor T3 remains in the turn-off state.

During the third period P3, the enable first scan signal GW is supplied to the first scan line SL1i. When the enable first scan signal GW is supplied to the first scan line SL1i, the second transistor T2 is turned on. When the second transistor T2 is turned on, a data signal from the data line DLj may be supplied to the first node N1.

During the third period P3, the voltages at the first node N1 and the second node N2 may be represented as shown in Equation 1.

$$VN 1 = Vdata \qquad Equation 1$$

$$VN 2 = VREF - Vth 1$$

In Equation 1, Vdata may be the voltage of the data signal, and Vth1 may be the threshold voltage of the first transistor T1.

In Equation 1, the second node N2 maintains a voltage of VREF-Vth1 during the third period P3 for convenience of illustration. However, the present invention is not limited thereto.

For example, during the third period P3, the first node N1 may change from the reference voltage VREF to a voltage Vdata of a data signal, and the voltage of the second node N2 may also be changed by coupling of the first capacitor Cst. However, the voltage of the second node N2 may be changed in response to a ratio of the first capacitor Cst and the second capacitor Chold, and the amount of voltage change of the second node N2 may be minimized or reduced accordingly. Hereinafter, for convenience of illustration, it is assumed that the second node N2 maintains the voltage VREF-Vth1 during the third period P3.

The voltage stored in the first capacitor Cst during the third period P3 may be determined by the reference voltage VREF and the voltage Vdata of the data signal. For example, the pixel PXij may generate light of a desired luminance (e.g., a predetermined luminance) based on a voltage difference between the reference voltage VREF and the voltage Vdata of the data signal. Because the reference voltage VREF may have (e.g., may be set to) a constant voltage, the luminance of the pixel PXij may be determined by the voltage Vdata of the data signal.

During the fourth period P4, the supply of the disable first emission control signal EM1 to the first emission control line EL1i is maintained, and the enable second scan signal GI may be supplied to the second scan line SL2i. When the enable second scan signal GI is supplied to the second scan line SL2i, the fourth transistor T4 is turned on. When the fourth transistor T4 is turned on, the initialization voltage VINT may be supplied to the third node N3. When the initialization voltage VINT is supplied to the third node N3, the first electrode of the light emitting device LD (e.g., the parasitic capacitor of the light emitting device LD) may be initialized to the initialization voltage VINT.

During the fourth period P4, the supply of the disable second emission control signal EM2 to the second emission control line EL2i is maintained, and the third transistor T3 remains in the turn-off state accordingly. Therefore, the initialization voltage VINT supplied to the third node N3 during the fourth period P4 is not supplied to the second node N2.

During the fifth period P5, the enable first emission control signal EM1 is supplied to the first emission control line EL1i. When the enable first emission control signal EM1 is supplied to the first emission control line EL1i, the sixth transistor T6 is turned on. When the sixth transistor T6 is turned on, the first power line PL1 and the first transistor T1 may be electrically connected to each other.

During the fifth period P5, the enable second emission control signal EM2 is supplied to the second emission control line EL2i. When the enable second emission control signal EM2 is supplied to the second emission control line EL2i, the third transistor T3 is turned on. When the third transistor T3 is turned on, the second node N2 and the third node N3 may be electrically connected to each other.

During the fifth period P5, the first transistor T1 may supply a driving current corresponding to the voltage of the first node N1 from the first driving power supply VDD to the second driving power supply VSS via the light emitting device LD. Thus, during the fifth period P5, the light emitting device LD may generate light having a luminance corresponding to the driving current.

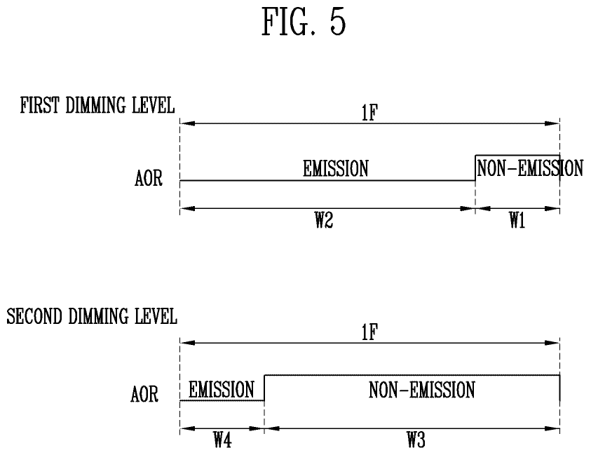

FIG. 5 is a diagram illustrating an AMOLED Off Ratio (AOR) based on a dimming level according to an embodiment of the present disclosure.

The display device 100 may be driven at a plurality of dimming levels. The dimming levels may include a maximum display luminance at which the display device 100 emits light. For example, as the dimming level increases, the maximum display luminance displayed on the display panel 110 may increase. The maximum display luminance may be a luminance that is measured when the entirety of the display panel 110 emits light at a maximum grayscale set by the display device 100.

Referring to FIG. 5, when the display device 100 is driven at a first dimming level, the pixels PX may not emit light during a period of a first width W1, and may emit light during a period of a second width W2 in one frame 1F. The second width W2 may be a relatively larger period as compared to that of the first width W1.

When the display device 100 is driven at a second dimming level, the pixels PX may not emit light during a period of a third width W3, and may emit light during a period of a fourth width W4 in one frame 1F. The fourth width W4 may be a relatively shorter period as compared to that of the third width W3.

The timing control signal TCS received by the timing controller 160 may include a dimming signal including a dimming level. The timing controller 160 may determine an AMOLED off ratio (AOR) of the pixels PX based on the dimming level included in the dimming signal. An Active Matrix Organic Light Emitting Diode (AMOLED) off ratio (AOR) may refer to a ratio of a time length of a non-emitting period to a time length of a light emitting period and a non-emitting period of the pixels PX (e.g., a time length of at least one frame period), and may be referred to as an AOR.

The timing controller 160 may control a width of an emission start signal (e.g., at least one of EFLM1 or EFLM2), such that a non-emission time may be adjusted with an AOR corresponding to a dimming level. The technique of controlling the width of the emission start signal to achieve a desired dimming level (e.g., a desired luminance level) may be referred to as an AMOLED Impulsive Driving (AID) dimming scheme.

Hereinafter, the first dimming level corresponds to a maximum dimming level of the display device 100, and may refer to a dimming level having the minimum AOR. The second dimming level corresponds to a minimum dimming level of the display device 100, and may refer to a dimming level having the maximum AOR.

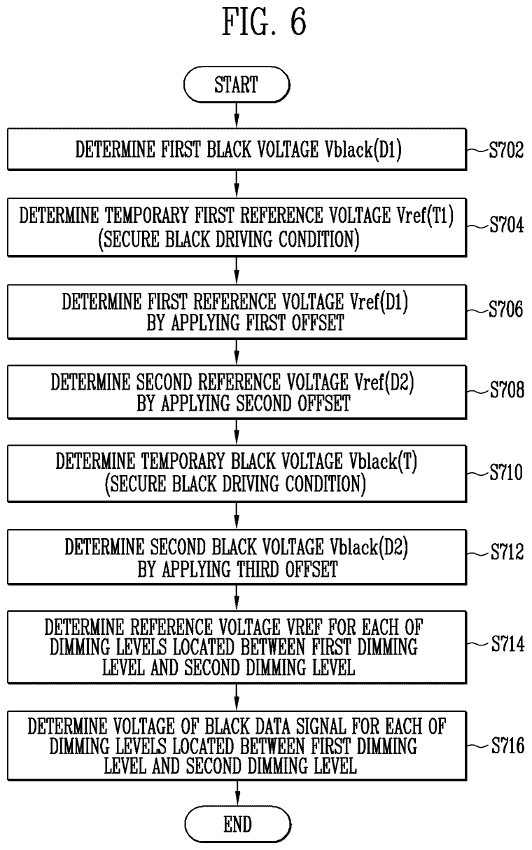

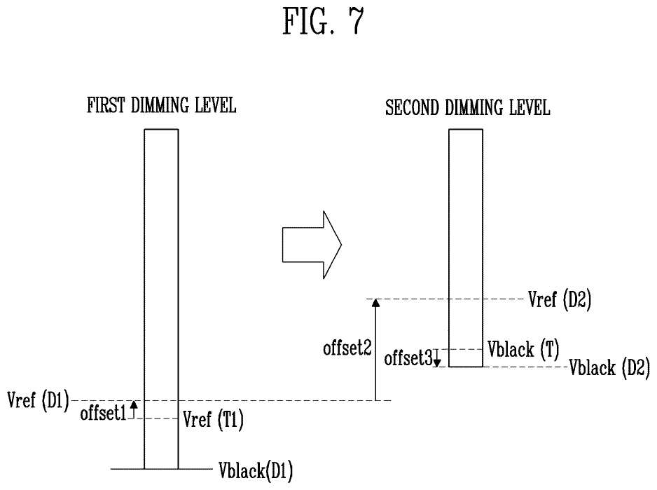

FIG. 6 is a flowchart illustrating a voltage setting method of display devices according to some embodiments of the present disclosure. FIG. 7 is a diagram illustrating the voltage setting method of FIG. 6.

Referring to FIGS. 6 and 7, the method may start, and a first black voltage Vblack(D1) may be determined (S702), where the first black voltage Vblack(D1) corresponds to a black data signal when the pixels PX are driven at the first dimming level. The first black voltage Vblack(D1) may have (e.g., may be set to) the same or substantially the same voltage in each of the display panels (e.g., display devices), which are generated in the same processes, for example, such as display panels having the same inches, resolution, and the like. The first black voltage Vblack(D1) may be determined experimentally.

After the first black voltage Vblack(D1) is determined, a temporary first reference voltage Vref(T1) may be determined to ensure a black driving condition (S704). The temporary first reference voltage Vref(T1) may be determined to be a voltage at which a black luminance is realized at the first dimming level based on the first black voltage Vblack(D1). The temporary first reference voltage Vref(T1) may have a different voltage value for each display panel based on the characteristics of each of the display panels.

After the temporary first reference voltage Vref(T1) is determined, a first reference voltage Vref(D1) may be determined by adding a first offset offset1 (or a second offset) voltage to the temporary first reference voltage Vref(T1) (S706). The first reference voltage Vref(D1) may correspond to the reference voltage VREF when the pixels PX are driven at the first dimming level.

The first offset offset1 may be preset to a predetermined voltage to compensate for a degradation of the light emitting device LD, process deviations (e.g., process margins), and the like. For example, when the first offset offset1 voltage is included in the first reference voltage Vref(D1), a black luminance may be realized at the first dimming level stably even when the light emitting device LD included in the pixels PX is deteriorated.

At processes S704 and S706, the first reference voltage Vref(D1) may be determined based on the first black voltage Vblack(D1). The first reference voltage Vref(D1) may have a different voltage value for each display panel based on characteristics of the display panels.

After the first reference voltage Vref(D1) is determined, a second reference voltage Vref(D2) may be determined by adding a second offset offset2 (or a first offset) voltage to the first reference voltage Vref(D1) (S708). The second reference voltage Vref(D2) may correspond to the reference voltage VREF when the pixels PX are driven at the second dimming level. The second offset offset2 may be a value that is set beforehand by taking into account load variations, temperature variations, and the like of the display panel, and may be applied uniformly across the display panels.

After the second reference voltage Vref(D2) is determined, a temporary black voltage Vblack(T) may be determined to ensure a black driving condition (S710). The temporary black voltage Vblack(T) may be determined to be a voltage at which a black luminance is realized at the second dimming level relative to the second reference voltage Vref(D2). The temporary black voltage Vblack(T) may have a different voltage for each display panel based on the characteristics of each of the display panels.

After the temporary black voltage Vblack(T) is determined, a second black voltage Vblack(D2) may be determined by subtracting a third offset offset3 voltage from the temporary black voltage Vblack(T) (S712). The second black voltage Vblack(D2) may correspond to the voltage of the black data signal when the pixels PX are driven at the second dimming level.

The third offset offset3 may be preset to a predetermined voltage to compensate for a degradation of the light emitting device LD, process variations (e.g., process margins), and the like. For example, when the second black voltage Vblack(D2) includes the third offset offset3 voltage, the pixels PX may realize the black luminance stably at the second dimming level even when the light emitting device LD is deteriorated.

At processes S710 and S712, the second black voltage Vblack(D2) may be determined based on the second reference voltage Vref(D2). The second black voltage Vblack(D2) may have a different voltage for each display panel based on the characteristics of the display panels.

When the voltage is set by the voltage setting method as described with reference to FIG. 6, at least two display panels (e.g., the same type of panels which have undergone the same processes) may have the same voltage of the black data signal (e.g., Vblack(D1)) at the first dimming level, and may have different voltages of the black data signal (e.g., Vblack(D2)) at the second dimming level. Further, the first reference voltage (e.g., Vref(D1)) and the second reference voltage (e.g., Vref(D2)) may be set differently in at least two display panels.

As described above, the voltage setting method according to some embodiments of the present disclosure may determine the voltage of the reference voltage VREF and the voltage of the black data signal in consideration of the characteristics of the display panel, and may improve the display quality of the display device 100 accordingly.

After the first reference voltage Vref(D1) and the second reference voltage Vref(D2) are determined at processes S702 to S712, the reference voltage VREF for each of the dimming levels located between the first dimming level and the second dimming level may be obtained by interpolating the first reference voltage Vref(D1) and the second reference voltage Vref(D2) (S714).

After the first black voltage Vblack(D1) and the second black voltage Vblack(D2) are determined at processes S702 to S712, the voltage of the black data signal at each of the dimming levels located between the first dimming level and the second dimming level may be obtained by interpolating the first black voltage Vblack(D1) and the second black voltage Vblack(D2) (S716), and the method may end.

Furthermore, since the second dimming level has a large AOR, for example, because a grayscale is realized at a shorter emission time, the third offset offset3 voltage may have a higher voltage value than that of the first offset offset1 voltage, taking into account the characteristics of each of the display panels. For example, the third offset offset3 voltage is experimentally set to have a similar effect to the first offset offset1 voltage, but may have a higher voltage than that of the first offset offset1 voltage in consideration of the characteristics of each of the display panels.

If (e.g., when) the third offset offset3 voltage has a higher voltage value than that of the first offset offset1 voltage, a voltage width of a data signal (e.g., a voltage difference between a black voltage and a white voltage) at the second dimming level may (e.g., may be set to) be wide (e.g., larger), and low DBV copy Mura (LDCM) may (e.g., may be set to) be larger accordingly. The LDCM may refer to screen non-uniformity that appears in a low brightness state of the display panel 110.

For example, when the display device 100 is driven at the second dimming level, the pixels PX may emit light for a shorter period of time. When data signals with a high voltage difference are continuously supplied to the data lines DL1 to DLm, a coupling between parasitic capacitors included in each of the pixels PX and the data lines DL1 to DLm may result in a change in the luminance of the pixels PX, thereby increasing the LDCM.

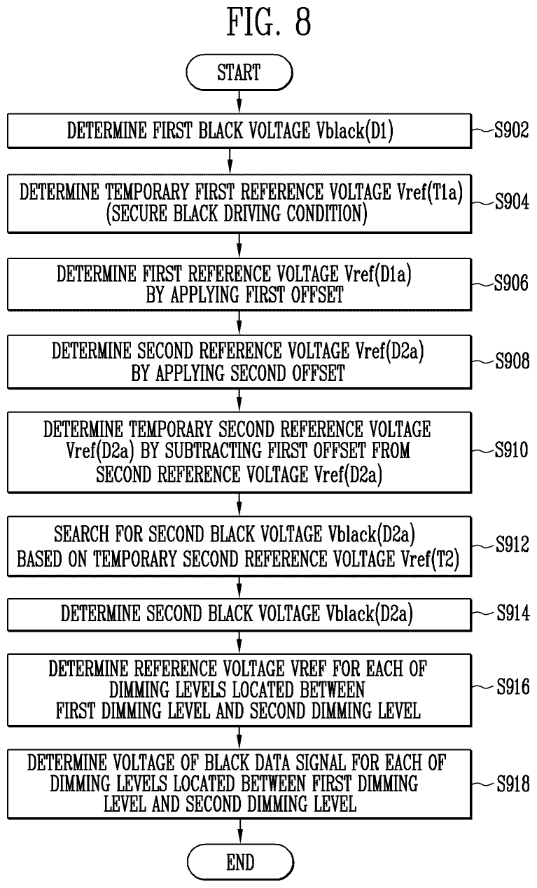

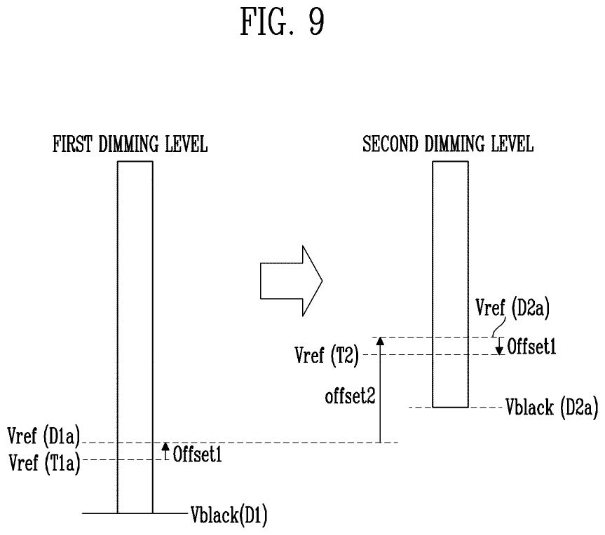

FIG. 8 is a flowchart illustrating a voltage setting method of display devices according to some embodiments of the present disclosure. FIG. 9 is a diagram illustrating the voltage setting method of FIG. 8. In FIGS. 8 and 9, the same or substantially the same portions as those described above with reference to FIGS. 6 and 7 may be briefly described hereinafter, or redundant description thereof may not be repeated.

Referring to FIGS. 8 and 9, the method may start, and the first black voltage Vblack(D1) corresponding to the black data signal at the first dimming level is determined first (S902). The first black voltage Vblack(D1) may have (e.g., may be set to) the same voltage in display panels (e.g., display devices) generated in the same processes, for example, such as display panels having the same inches, resolution, and the like.

After the first black voltage Vblack(D1) is determined, a temporary first reference voltage Vref(T1a) may be determined to ensure a black driving condition (S904). The temporary first reference voltage Vref(T1a) may have a different voltage for each display panel based on the characteristics of each of the display panels.

After the temporary first reference voltage Vref(Ta) is determined, a first reference voltage Vref(D1a) may be determined by adding the first offset1 (or a second offset) voltage to the temporary first reference voltage Vref(T1a) to determine the first reference voltage Vref(D1a) (S906).

After the first reference voltage Vref(D1a) is determined, a second reference voltage Vref(D2a) may be determined by adding a second offset offset2 (or a first offset) voltage to the first reference voltage Vref(D1a) (S908).

After the second reference voltage Vref(D2a) is determined, a temporary second reference voltage Vref(T2) may be determined by subtracting the first offset offset1 voltage from the second reference voltage Vref(D2a) (S910). After the temporary second reference voltage Vref(T2) is determined, the second black voltage Vblack(D2a) may be searched for based on the temporary second reference voltage Vref(T2), and the second black voltage Vblack(D2a) satisfying the black driving condition may be determined at processes S912 and S914.

In an embodiment of the present disclosure, after the first offset offset1 voltage is reflected in the second reference voltage Vref(D2a) (S910), the second black voltage Vblack(D2a) satisfying the black driving condition may be determined in processes S912 and S914. The second black voltage Vblack(D2a) may be set considering the characteristics of the panel, and may include the first offset offset1 voltage which is lower than the third offset offset3 voltage.

When the second black voltage Vblack(D2a) includes the first offset offset1 voltage, the second black voltage Vblack(D2a) may have a relatively higher voltage as compared to when the second black voltage Vblack(D2a) includes the third offset offset3 voltage. When compared to the case where the second black voltage Vblack(D2) includes the third offset offset3 voltage, the voltage width of the data signal may be narrower (e.g., smaller) than that of the case where the second black voltage Vblack(D2a) includes the first offset offset1 voltage. As a result, the LDCM may be reduced.

In an embodiment, the pixels PX may include a red pixel, a green pixel, and a blue pixel. The second black voltage Vblack(D2) or Vblack(D2a) of the red pixel may be set by the voltage setting method of FIG. 6 or FIG. 8. The second black voltage Vblack(D2) or Vblack(D2a) of the green pixel may be set by the voltage setting method of FIG. 6 or FIG. 8. The second black voltage Vblack(D2) or Vblack(D2a) of the blue pixel may be set by the voltage setting method of FIG. 6 or FIG. 8. The second black voltages Vblack(D2) or Vblack(D2a) of the red pixel, the green pixel, and/or the blue pixel may have different voltage values.

In an embodiment, the second black voltage Vblack(D2a) of each of the red pixel and the blue pixel, which is set by the voltage setting method of FIG. 8, may be a voltage of about 90 mV higher than the second black voltage Vblack(D2) of each of the red pixel and the blue pixel, which is set by the voltage setting method of FIG. 6 based on the same panel.

In an embodiment, the second black voltage Vblack(D2a) of the green pixel, which is set by the voltage setting method of FIG. 8, may be a voltage of about 150 mV higher than the second black voltage Vblack(D2) of the green pixel, which is set by the voltage setting method of FIG. 6 on the basis of the same panel.

For example, when the second black voltage Vblack(D2) is determined by the voltage setting method of FIG. 6, the LDCM may be about 2.27%. For example, when the second black voltage Vblack(D2a) is determined by the voltage setting method of FIG. 8, the LDCM may be about 1.92% or less. For example, when the second black voltage Vblack(D2a) is determined by the voltage setting method of FIG. 8, there may be an LDCM improvement effect of about 0.3% or more as compared to the case where the second black voltage Vblack(D2) is determined by the voltage setting method of FIG. 6, and a display quality may be improved accordingly.

When the voltage is set according to the voltage setting method as shown in FIG. 8, at least two display panels (e.g., the same type of panels which have undergone the same processes) may have the same voltage of the black data signal (e.g., Vblack(D1)) at the first dimming level, and may have different voltages (e.g., Vblack(D2a)) of the black data signal at the second dimming level. Further, in at least two display panels, the first reference voltage (e.g., Vref(D1a)) and the second reference voltage (e.g., Vref(D2a)) may be set differently.

After the first reference voltage Vref(Da) and the second reference voltage Vref(D2a) are determined at processes S902 to S914, the reference voltage VREF for each of the dimming levels located between the first dimming level and the second dimming level may be obtained by interpolating the first reference voltage Vref(D1a) and the second reference voltage Vref(D2a) (S916).

After the first black voltage Vblack(D1) and the second black voltage Vblack(D2a) are determined at processes S902 to S914, the voltage of the black data signal at each of the dimming levels located between the first dimming level and the second dimming level may be obtained by interpolating the first black voltage Vblack(D1) and the second black voltage Vblack(D2a) (S918), and the method may end.

The methods described above with reference to FIGS. 6 and 8 may be performed or implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

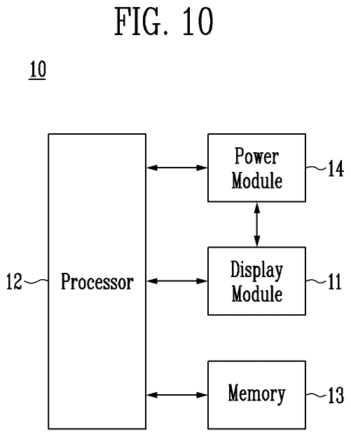

FIG. 10 is a block diagram of an electronic device 10 according to some embodiments of the present disclosure.

Referring to FIG. 1, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals, and output image information on a display screen.

The power module 14 may include a power supply module, such as a power adapter or a battery device, and a power conversion module. The power conversion module converts power supplied by the power supply module, and generates power to operate the electronic device 10.

At least one of the above-described components of the electronic device 10 may be included in the display device according to some embodiments as described above. In addition, in terms of functionality, some of the individual modules included in one module may be included in the display device, and others may be provided separately from the display device. For example, the display module 11 is included in the display device, whereas the processor 12, the memory 13, and the power module 14 are not included in the display device, and are instead provided separately in the electronic device 10.

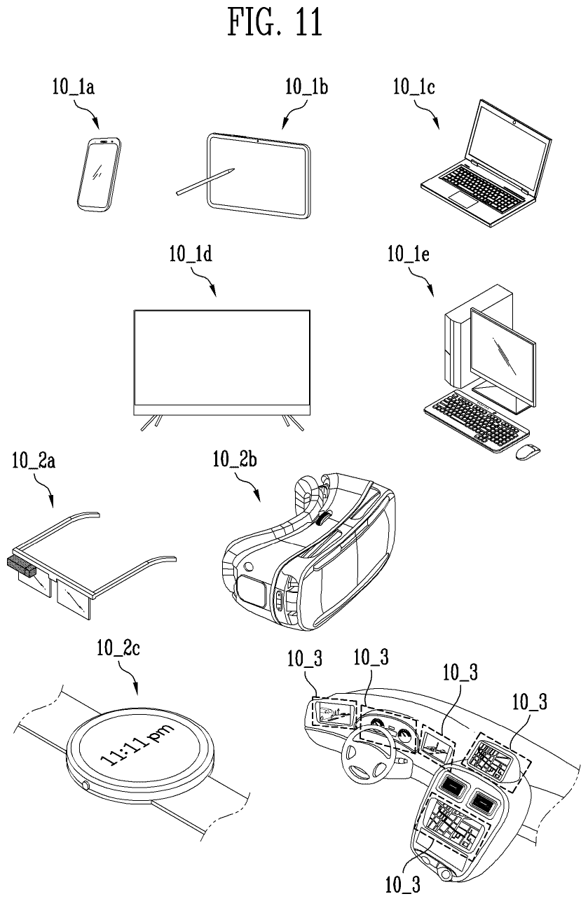

FIG. 11 shows schematic views of various electronic devices according to some embodiments of the present disclosure.

Referring to FIG. 11, various kinds of electronic devices to which embodiments of a display device may be applied may include an electronic device to display images, such as a smartphone 10_1a, a tablet PC 10_1b, a laptop computer 10_1c, a television (TV) 10_1d, and a desktop monitor 10_1e, a wearable electronic device including a display module, such as smart glasses 10_2a, a head-mounted display (HMD) 10_2b, and a smart watch 10_2c, and an automotive electronic device 10_3 including a display module, such as a center information display (CID) disposed at the instrument cluster, the center fascia, and the dashboard of a vehicle, and a room mirror display.

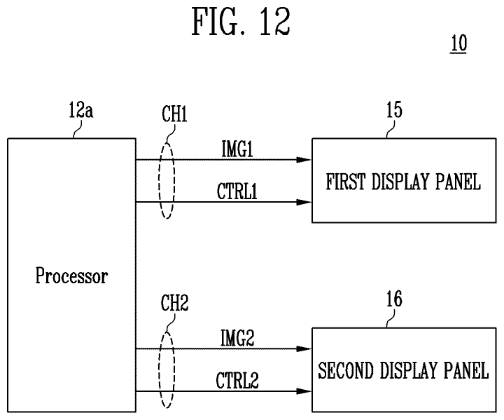

FIG. 12 is a diagram showing an application example of the electronic device 10 of FIG. 10.

Referring to FIG. 12, the electronic device 10 may include a processor 12a, a first display panel 15, and a second display panel 16.

The processor 12a may be coupled to the first display panel 15 via a first channel CH1, and may be coupled to the second display panel 16 via a second channel CH2.

Through the first channel CH1, the processor 12a may transmit first image data IMG1 and a first control signal CTRL1 to the first display panel 15. The first display panel 15 may display an image based on the first image data IMG1 and the first control signal CTRL1. The first display panel 15 may be the display device 100 (e.g., the display panel 110) as described above with reference to FIG. 1. The first image data IMG1 and the first control signal CTRL1 may be provided as the input data Din and the timing control signal TCS, as shown in FIG. 1, respectively.

Through the second channel CH2, the processor 12a may transmit second image data IMG2 and a second control signal CTRL2 to the second display panel 16. The second display panel 16 may display an image based on the second image data IMG2 and the second control signal CTRL2. The second display panel 16 may be the display device 100 (e.g., the display panel 110) as described with reference to FIG. 1. The second image data IMG2 and the second control signal CTRL2 may be provided as the input data Din and the timing control signal TCS shown in FIG. 1, respectively.

The first display panel 15 and the second display panel 16 may include the pixels PX that are driven based on the reference voltage VREF and the voltage of the data signal. For example, the first display panel 15 and the second display panel 16 may include the pixels as shown in FIG. 3, but the present disclosure is not limited thereto.

The pixels PX included in the first display panel 15 and the second display panel 16 may receive the reference voltage VREF, and a voltage of the black data signal as set by the voltage setting method of FIG. 6 or FIG. 8. In an embodiment, the first display panel 15 and the second display panel 16 may have the same voltage of the black data signal at the first dimming level, and different voltages of the black data signal at the second dimming level.

According to some embodiments of the present disclosure, a voltage setting method of display devices, a display device, and an electronic device may be provided that set a reference voltage and a voltage of a data signal supplied to the pixels by reflecting a characteristic of a display panel, thereby improving a display quality.

Furthermore, according to some embodiments of the present disclosure, the voltage setting method of the display device, the display device, and the electronic device may be provided that reduce a voltage range of a data signal at a low dimming level, thereby improving a display quality.

However, the aspects and features of the present disclosure are not limited to those described above, and various other aspects and features will be understood by those having ordinary skill in the art.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A voltage setting method of display devices comprising pixels configured to generate light based on a reference voltage and a voltage of a data signal, the method comprising:
determining a first reference voltage corresponding to the reference voltage at a first dimming level, based on a first black voltage corresponding to a black data signal at the first dimming level;
determining a second reference voltage corresponding to the reference voltage at a second dimming level by adding a first offset voltage to the first reference voltage; and
determining a second black voltage corresponding to a black data signal at the second dimming level, based on the second reference voltage.

2. The voltage setting method of claim 1, wherein the first black voltage in at least two of the display devices have a same voltage value, and the second black voltage in the at least two of the display devices have different voltage values from each other.

3. The voltage setting method of claim 1, wherein the first dimming level has a smallest AMOLED Off Ratio (AOR), and the second dimming level has a largest AOR.

4. The voltage setting method of claim 1, wherein the first reference voltage has a greater voltage value than that of the first black voltage, and the second reference voltage has a greater voltage value than that of the second black voltage.

5. The voltage setting method of claim 1, further comprising determining reference voltages for dimming levels located between the first dimming level and the second dimming level by interpolating the first reference voltage and the second reference voltage.

6. The voltage setting method of claim 1, further comprising determining black voltages for dimming levels located between the first dimming level and the second dimming level by interpolating the first black voltage and the second black voltage.

7. The voltage setting method of claim 1, wherein the determining of the first reference voltage comprises:
determining a temporary first reference voltage at which a black driving condition for the first dimming level is secured, based on the first black voltage; and
determining the first reference voltage by adding a second offset voltage to the temporary first reference voltage.

8. The voltage setting method of claim 7, wherein the determining of the second black voltage comprises:
determining a temporary black voltage at which a black driving condition is secured at the second dimming level, based on the second reference voltage; and
determining the second black voltage by subtracting a third offset voltage from the temporary black voltage.

9. The voltage setting method of claim 8, wherein the third offset voltage has a greater voltage value than that of the second offset voltage.

10. The voltage setting method of claim 7, wherein the determining of the second black voltage comprises:
determining a voltage obtained by subtracting the second offset voltage from the second reference voltage as a temporary second reference voltage; and
determining the second black voltage satisfying a black driving condition at the second dimming level, based on the temporary second reference voltage.

11. A voltage setting method of display devices comprising pixels configured to be driven based on a reference voltage and a voltage of a data signal, the voltage setting method comprising:
determining a temporary first reference voltage satisfying a black driving condition, based on a first black voltage corresponding to a black data signal at a first dimming level;
determining a first reference voltage corresponding to the reference voltage at the first dimming level by adding a first offset voltage to the temporary first reference voltage;
determining a second reference voltage corresponding to the reference voltage at a second dimming level by adding a second offset voltage to the first reference voltage;
determining a temporary second reference voltage by subtracting the first offset voltage from the second reference voltage; and
determining a second black voltage corresponding to the black data signal at the second dimming level, based on the temporary second reference voltage.

12. The voltage setting method of claim 11, wherein the first black voltage in at least two of the display devices have a same voltage value, and the second black voltage in the at least two of the display devices have different voltage values from each other.

13. The voltage setting method of claim 11, wherein the first dimming level has a smallest AMOLED Off Ratio (AOR), and the second dimming level has a largest AOR.

14. The voltage setting method of claim 11, wherein the first reference voltage has a greater voltage value than that of the first black voltage, and the second reference voltage has a greater voltage value than that of the second black voltage.

15. The voltage setting method of claim 11, further comprising determining reference voltages for dimming levels located between the first dimming level and the second dimming level by interpolating the first reference voltage and the second reference voltage.

16. The voltage setting method of claim 11, further comprising determining black voltages for dimming levels located between the first dimming level and the second dimming level by interpolating the first black voltage and the second black voltage.

17. An electronic device comprising:
a first display panel;
a second display panel; and
a processor configured to drive the first display panel and the second display panel,
wherein voltages of black data signals at a first dimming level are same in the first display panel and the second display panel, and
wherein voltages of black data signals at a second dimming level are different in the first display panel and the second display panel.

18. The electronic device of claim 17, wherein the first dimming level has a smallest AMOLED Off Ratio (AOR), and the second dimming level has a largest AOR.
